(19) United States
(12) Patent Application Publication
(10) Pub. No.: US 2026/0286557 A1
(43) Pub. Date: Sep. 24, 2026

(54) MONITORING AND CONTROL OF WATER QUALITY FOR WATER ELECTROLYZER USED TO GENERATE HYDROGEN

(71) Applicant: Ecolab USA Inc., St. Paul, MN (US)

(72) Inventors: Michael Patrick Weberski, JR., Sugar Grove, IL (US); Anupam Prakash, Aurora, IL (US); Jason Robert Burney, Aurora, IL (US); Nora Renee Eibergen, North Aurora, IL (US)

(21) Appl. No.: 19/574,280

(22) Filed: Mar. 21, 2026

Related U.S. Application Data
(60) Provisional application No. 63/775,865, filed on Mar. 21, 2025.

(51) Int. Cl. C25B 15/029; C25B 1/04; C25B 9/23; C25B 13/08; C25B 15/08

(52) U.S. Cl. CPC C25B 15/029; C25B 1/04; C25B 9/23; C25B 13/08; C25B 15/087

(57) ABSTRACT

A method of monitoring and controlling water quality for a water electrolyzer may involve analyzing the fluoride ion concentration in excess water discharged from the water electrolysis cell. The measured fluoride ion concentration in the excess water can be compared to a fluoride ion concentration threshold. If the measured fluoride ion concentration is below the fluoride ion concentration threshold, the excess water can be recycled as the feed water to the water electrolysis cell. By contrast, if the measured fluoride ion concentration is above the fluoride ion concentration threshold, one or more control actions can be taken to enhance the purity of the water supplied to the water electrolysis cell.

### RELATED APPLICATION

This application claims priority to U.S. Provisional Application No. 63/775,865, filed Mar. 21, 2025, the entire contents of which are hereby incorporated by reference.

### TECHNICAL FIELD

This disclosure relates to water electrolysis using a polymer electrolyte membrane and, more particularly, to systems and techniques for controlling water quality for such water electrolysis systems.

### BACKGROUND

Water electrolysis is a process that uses electrical energy to split water molecules (H₂O) into their constituent elements, hydrogen (H₂) and oxygen (O₂). This process typically occurs in an electrolyzer, which is formed of two electrodes—an anode and a cathode—immersed in an electrolyte solution. When an electric current is applied across the electrodes, water molecules are dissociated at the anode, producing oxygen gas and positively charged hydrogen ions (protons). These protons travel through the electrolyte to the cathode, where they combine with electrons to form hydrogen gas. This reaction is governed by the principles of electrochemistry, with the overall chemical reaction being 2H₂O→2H₂+O₂. The efficiency of water electrolysis depends on factors such as electrode materials, electrolyte composition, and operating conditions like temperature and voltage.

An advancement in water electrolysis technology is the use of Solid Polymer Electrolyte Membrane (SPEM) electrolyzers, which employ a solid polymer membrane as the electrolyte. In SPEM electrolyzers, also known as Proton Exchange Membrane (PEM) electrolyzers, the solid polymer membrane allows for the selective conduction of protons while preventing the mixing of hydrogen and oxygen gases. PEM electrolyzers are of interest for producing green hydrogen as they can be paired with renewable energy sources like solar and wind, making them an ideal solution for sustainable hydrogen production.

### SUMMARY

In general, this disclosure is directed to water electrolyzers utilizing solid polymer electrolyte membranes and, more particularly, to systems and techniques for controlling the supply and/or quality of water delivered to such an electrolyzer for electrolysis. Proton Exchange Membrane (PEM) electrolyzers that utilize a solid polymer membrane require comparatively high purity feed water (e.g., ultrapure water) to avoid poisoning of the electrodes and reduced reaction efficiency. In practice, it has been observed that the solid polymer membrane in a PEM electrolyzer can degrade and/or shed impurities into the electrolysis feed water. For example, the solid polymer membrane may release ions into the electrolysis feed water that form impurities in the water. These impurities can disrupt the operation of the electrolyzer, e.g., by impairing the performance of the electrodes and the electrolyte, reducing proton conductivity, and increasing internal resistance. This may necessitate frequent maintenance, leading to higher operational costs and a shorter lifespan for the system.

In according with some implementations of the present disclosure, systems and techniques are described for monitoring one or more indicators associated with one or more impurities in the water fed to the electrolyzer and controlling the water based on the one or more monitored indicators. For example, applicant has identified that the fluoride ion concentration in the water fed to the electrolyzer can indicate the quality of the water and suitability of the water for continued use in hydrogen generation using the electrolyzer. The solid polymer membrane may typically be fluorine-containing that can shed fluoride ions into the feed water. Accordingly, monitoring the fluoride ion concentration in the water can indicate the health and purity of the water and, correspondingly, suitability of continuing to use the feed water.

In some examples, electrolyzer systems and corresponding control techniques can be implemented that allow the excess water remaining after electrolysis to be recycled back to the electrolyzer and reused without undergoing an intermediate purification step and/or without supplementing the feed water with additional purified water. During operation, a feed water can be supplied to the electrolyzer and an electrical current supplied to the electrodes to separate a portion of the feed water into hydrogen and oxygen. A remaining portion of the feed water that is not broken down into constituent atoms can be separated and recycled back to the feed inlet of the electrolyzer. In accordance with some implementations of the present disclosure, the water may be recycled in a closed loop fashion while continuously monitoring one or more impurity characteristics in the water, such as the fluoride ion concentration in the water. When the monitored impurity reaches a threshold level, one or more control actions can be taken in the electrolysis system.

As one example, at least a portion of the water recycle may be diverted to an ultrapure water generation system, which may include an ion exchange membrane, to remove impurities and purify the water. The resulting purified water may then be directed back to the electrolyzer. Additionally or alternatively, the water recycle may be supplemented with purified water (e.g., from the ultrapure water generation system), e.g., resulting in dilution of the impurity content in the feed water to the electrolyzer, optionally without diverting a portion of the water recycle back to the water purification system. Yet further additionally or alternatively, at least a portion of the water recycle may be diverted out of the water system for the electrolyzer such that the diverted water is no longer delivered as part of the feed stream to the electrolyzer. This diverted water, along with any impurities contained therein, can be discarded or used for other process applications at the location where the electrolyzer is positioned.

In one example, a method of monitoring and controlling water quality for a water electrolyzer is described. The method includes supplying a feed water to a water electrolysis cell having a solid polymer electrolyte membrane and generating hydrogen and oxygen through electrolysis of the feed water supplied to the water electrolysis cell. The example specifies that excess water is discharged from the water electrolysis cell and that technique involves measuring, with a fluoride ion sensor, a fluoride ion concentration in the excess water to provide a measured fluoride ion concentration in the excess water. The example technique also involves comparing, by one or more processors, the measured fluoride ion concentration to a fluoride ion concentration threshold. The example specifies that, if the measured fluoride ion concentration is below the fluoride ion concentration threshold, the technique involves recycling the excess water as the feed water to the water electrolysis cell while, if the measured fluoride ion concentration is above the fluoride ion concentration threshold, the method involves taking a control action for the excess water.

In another example, a method of monitoring and controlling water quality for a water electrolyzer is described. The method includes operating a water electrolysis cell having a solid polymer electrolyte membrane that generates hydrogen and oxygen through electrolysis of a feed water supplied to the water electrolysis cell in a closed loop with excess water discharged from the water electrolysis cell recycled back as the feed water. The method involves measuring, with a fluoride ion sensor, a fluoride ion concentration in the excess water to provide a measured fluoride ion concentration in the excess water and comparing, by one or more processors, the measured fluoride ion concentration to a fluoride ion concentration threshold. The method includes, when the measured fluoride ion concentration is above the fluoride ion concentration threshold, terminating closed loop operation of the water electrolysis cell by at least supplying ultrapure water from an ultrapure water generation system to the water electrolysis cell.

In another example, a water electrolysis system is described that includes a water electrolysis cell, a fluoride ion sensor, an ultrapure water generation system, and a controller. The example specifies that the water electrolysis cell has a solid polymer electrolyte membrane and is configured to receive a feed water and generate hydrogen and oxygen through electrolysis of the feed water. The water electrolysis cell is further configured to discharge excess water from the water electrolysis cell. The fluoride ion sensor is positioned to measure a fluoride ion concentration in the excess water to provide a measured fluoride ion concentration in the excess water. The ultrapure water generation system is in selective fluid communication with the water electrolysis cell. The controller is configured to receive the measured fluoride ion concentration from the fluoride ion sensor and compare the measured fluoride ion concentration to a fluoride ion concentration threshold. The controller is configured, if the measured fluoride ion concentration is below the fluoride ion concentration threshold, to control recycling of the excess water as the feed water to the water electrolysis cell. The controller is also configured to, if the measured fluoride ion concentration is above the fluoride ion concentration threshold, to control supply of ultrapure water to the water electrolysis cell from the ultrapure water generation system.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a diagram of an example water electrolysis cell.

FIG. 2 is a block diagram illustrating an example water electrolysis system that is configured to monitor and control water quality for the feed water supplied to a water electrolysis cell, such as that illustrated in FIG. 1.

### DETAILED DESCRIPTION

This disclosure generally relates to systems and techniques for monitoring and controlling water supplied to a water electrolysis cell of an electrolyzer system that electrolytically splits a portion of the supplied water into gaseous hydrogen and oxygen. The water electrolysis cell can include an anode and a cathode separated by a solid polymer electrolyte membrane. The solid polymer electrolyte membrane is typically fabricated from fluorine-containing polymeric molecules. During operation of the water electrolysis cell, the membrane release fluoride ions into the water supplied to the water electrolysis cell. As the feedwater is repeatedly recycled though the electrolysis system, the concentration of fluoride ions can increase in the water. In accordance with some examples of the present disclosure, a sensor can be installed to measure the fluoride ion concentration in the water to provide a measured fluoride ion concentration. This measured fluoride ion concentration can then be used to control the water supplied to the water electrolysis cell, e.g., by purifying at least a portion of the recycle water and/or introducing purified water into the feed water supply.

Water electrolysis cells typically require ultrapure water to operate efficiency. Even comparatively minor levels of impurities in the water can reduce the efficiency of the water electrolysis cell. A fluoride ion sensor can be implemented that can measure very low fluoride ion concentration levels, such as in the parts per billion or parts per trillion range. This can provide a comparatively early and accurate mechanism for detecting impurities in the feed water supply and determining when the impurities are reaching a level that warrants taking control action.

By accurately monitoring and controlling the water supply based on monitored impurity level, the excess water discharging from the water electrolysis cell may be recycled back to the feed water supplied and continuously reused (e.g., until the monitored impurity level reaches a threshold warranting a different control action). In some of these applications, the excess water may be recycled back to the feed supply without undergoing an intermediate water purification process. This reduces the size and operating requirements of any on-site ultrapure water generation system used with the water electrolysis cell, significantly improving the implementability and economics of the process. In other applications, the excess water recycled may undergo one or more purification steps before being recycled back to the feed supply (e.g., ion exchange, electrodeionization).

While fluoride ion concentration is attractively measured, e.g., because of the ability to accurately measure at very low concentrations, additional or different sensors may be implemented to measure additional or different water parameters indicative of water quality / impurity levels. In some examples, one or more secondary water characteristics other than fluoride ion concentration are measured and used as a control signal for taking a water control action in addition to fluoride ion concentration. This provides a safety interlock for control based on the measured fluoride ion concentration, e.g., in instances where impurities other than fluoride ions are accumulating in the feed water supply.

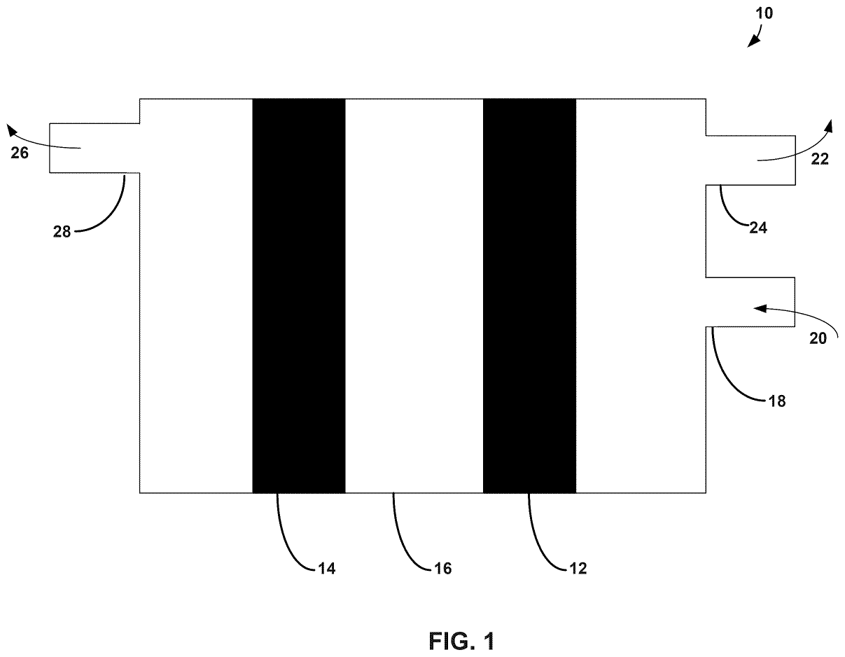

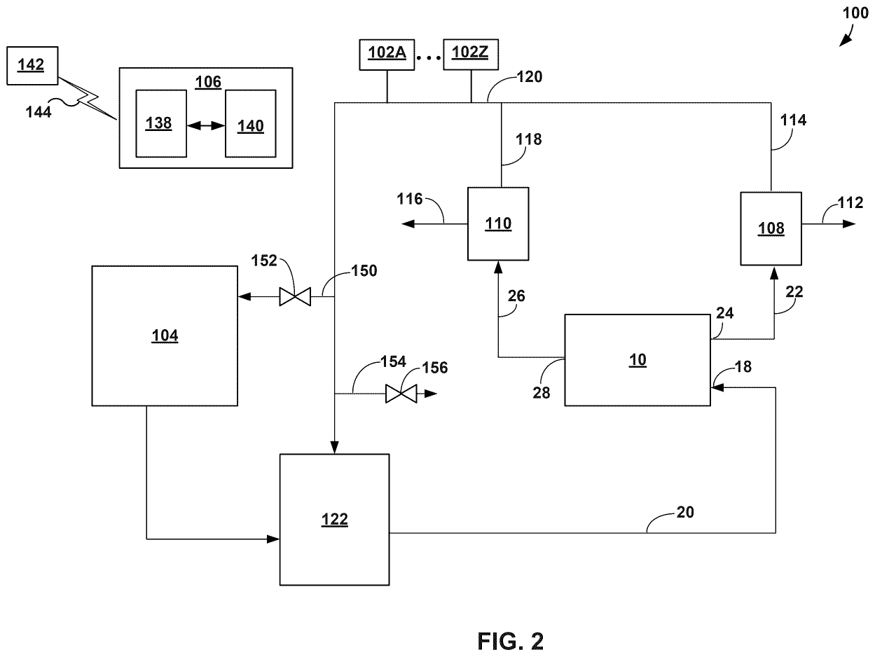

An example water electrolysis system that is configured to monitor and control water quality for a water electrolyzer is described in greater detail with respect to FIG. 2. However, an example water electrolysis cell that can be used in a water electrolysis system is first described with respect to FIG. 1.

FIG. 1 is a diagram of an example water electrolysis cell 10. Water electrolysis cell 10 in FIG. 1 is illustrated as having an anode electrode 12, a cathode electrode 14, and a solid polymer electrolyte membrane (PEM) 16 separating the anode from the cathode. In particular, in the illustrated example, solid polymer electrolyte membrane 16 is sandwiched between the anode electrode 12 and the cathode electrode 14. While FIG. 1 illustrates a single water electrolysis cell 10, in practice, multiple water electrolysis cells 10 may be arranged in parallel (e.g., and supplied from a common feed water source) and/or in series (e.g., with excess water from one electrolysis cell supplied to the next electrolysis cell in series).

In either case, example water electrolysis cell 10 can include a feedwater inlet 18 that receives a feedwater stream 20. An electric current can be supplied to water electrolysis cell 10 to split water (H₂O) molecules from the feedwater stream into hydrogen (H₂) and oxygen (O₂) gases. In particular, a direct current (DC) voltage may be applied across the anode electrode 12 (positive) and cathode electrode 14 (negative), resulting in water molecules at the anode being oxidized. This releases oxygen gas (O₂) and hydrogen ions (protons, H⁺). These hydrogen ions can pass through membrane 16 toward cathode electrode 14, where they gain electrons (reduction) and combine to form hydrogen gas (H₂).

At the anode (positive electrode), the reaction is:

2H₂O→O₂+4H⁺+4e⁻

At the cathode (negative electrode), the reaction is:

4H⁺+4e⁻→2H₂

Accordingly, the overall reaction for water electrolysis is:

2H₂O→2H₂+O₂

The amount of electricity required to be supplied to water electrolysis cell 10 can depends on factors such as the voltage applied and the efficiency of the water electrolysis cell 10. In some applications, the electricity supplied to water electrolysis cell 10 is received from a renewable energy source like solar, wind, or hydropower. The hydrogen gas produced from water electrolysis cell 10 when powered by a renewable energy source can be referred to as “green hydrogen.”

Water electrolysis cell 10 can generate an anode discharge stream 22 that exits water electrolysis cell 10 through an anode-side outlet 24. Anode discharge stream 22 can comprise excess water (feedwater supplied to water electrolysis cell 10 that has not been electrolytically decomposed into its constituent elements) and oxygen generated through the electrolysis process. Water electrolysis cell 10 can also generate a cathode discharge stream 26 that exits water electrolysis cell 10 through a cathode-side outlet 28. Cathode discharge stream 26 can comprise excess water (again feedwater supplied to water electrolysis cell 10 that has not been electrolytically decomposed into its constituent elements) and hydrogen generated through the electrolysis process.

Membrane 16 is a solid polymer electrolyte membrane. Membrane 16 may typically include or be formed of a fluorine-containing polymer, such as a fluorinated polymer having a sulfonic acid group. For example, membrane 16 may be formed from a perfluorosulfonic acid polymer. One commercially available perfluorosulfonic acid polymer frequently used in membrane construction is sold under the Nafion® brand. Other example materials that may be used to fabricate membrane 16 include, but are not limited to polybenzimidazole, sulfonated polyether ether ketone, polyarylene ether sulfone, and poly(2,6-dimethyl-1,4-phenylene oxide).

Anode electrode 12 is formed by a suitable electrically conductive material and may include a catalyst layer, such as an iridium oxide catalyst (IrOₓ). Cathode electrode 14 may also be formed by a suitable electrically conductive material, such as a mixture of a platinum-supported carbon catalyst or a platinum alloy-supported carbon catalyst and an ionomer.

FIG. 2 is a block diagram illustrating an example water electrolysis system 100 that is configured to monitor and control water quality for the feed water supplied to water electrolysis cell 10. System 100 is illustrating as including water electrolysis cell 10, which can be configured as described above with respect to FIG. 1 or have a different configuration suitable for performing the functions described as being performed by water electrolysis cell 10. System 100 also includes one or more sensors 102A-102Z (collectively “sensor 102”) providing information concerning one or more characteristics indicative of one or more impurities in the feed water supply to water electrolysis cell 10. System 100 further includes an ultrapure water generation system 104 operable to generate ultrapure water for supply to water electrolysis cell 10. In addition, system 100 includes a controller 106 that manages the overall operation of system 100.

In operation, water electrolysis cell 10 can generate anode discharge stream 22 that exits water electrolysis cell 10 through anode-side outlet 24 and cathode discharge stream 26 that exits water electrolysis cell 10 through a cathode-side outlet 28. Water electrolysis cell 10 may be in fluid communication with an oxygen-water separator 108 and/or a hydrogen-water separator 110 to separate excess water discharging from the water electrolysis cell from gas generated by the water electrolysis cell. For example, anode-side outlet 24 can be in fluid communication with oxygen-water separator 108. Oxygen-water separator 108 can receive anode discharge stream 22 and separate water in the stream (which can be referred to as excess water or anode-side excess water) from oxygen in the stream generated by the water electrolysis cell. Hydrogen-water separator 110 can receive cathode discharge stream 26 and separate water in the stream (which can be referred to as excess water or cathode-side excess water) from hydrogen in the stream generated by the water electrolysis cell.

Configuring system 100 with oxygen-water separator 108 and hydrogen-water separator 110 can allow the system to generate a gaseous separated oxygen stream 112, an anode-side excess water stream 114, a gaseous separated hydrogen stream 116, and a cathode-side excess water stream 118. Anode-side excess water stream 114 and cathode-side excess water stream 118 can be processed in a variety of different ways. In some examples, one or both of anode-side excess water stream 114 and cathode-side excess water stream 118 are recycled back to feed inlet 18 of water electrolysis cell 10 to again form part of feed stream 20 supplied to the cell for electrolysis.

For example, in the illustrated configuration, anode-side excess water stream 114 is illustrated as combining with cathode-side excess water stream 118 to form a combined excess water stream 120. In some examples, Anode-side excess water stream 114 and cathode-side excess water stream 118 combined directly. In other examples, system 100 may include a feedwater supply tank 122 that receives Anode-side excess water stream 114 and cathode-side excess water stream 118 to form the resulting combined excess water stream 120 at tank 122. Feed stream 20 may be provided, partially or fully, from feedwater supply tank 122 in such examples.

In operation, feedwater stream 20 can be supplied to water electrolysis cell 10, resulting in anode discharge stream 22 and cathode discharge stream 26. The excess water discharged from water electrolysis cell (e.g., water supplied to the water electrolysis cell that was not electrolytically converted into hydrogen and oxygen and therefore exits the water electrolysis cell as water) can be recycled and reused in system 100. For example, anode-side excess water stream 114 and/or cathode-side excess water stream 118 (e.g., combined excess water stream 120) may be recycled to feedwater inlet 18, thereby supplying and/or forming feed stream 20. Since anode-side excess water stream 114 may typically provide the bulk of the excess water from water electrolysis cell 10, some applications may involve recycling anode-side excess water stream 114 and reusing the anode-side excess water to supply feed stream 20 without recycling cathode-side excess water stream 118. Such a configuration may be useful because cathode-side excess water stream 118 may have a higher concentration of impurities than anode-side excess water stream 114.

Independent of whether anode-side excess water stream 114, cathode-side excess water stream 118, or both water streams are recycled to form and/or supply feedwater stream 20, the water may be recycled multiple times through water electrolysis cell 10. For example, the excess water discharging from water electrolysis cell 10 may be continuously recycled in a closed loop from the discharge of the water electrolysis cell back to the supply forming feed stream 20, e.g., until one or more control actions are taken based on information measured by sensor 102. The excess water from water electrolysis cell 10 may be recycled back to the supply forming feed stream 20 without processing the excess water to remove ions (e.g., processing the water through ultrapure water generation system 104) when operating in a closed loop. The excess water may be recycled multiple times through water electrolysis cell 10, such as at least five times, at least 10 times, at least 25 times, or at least 100 times, before taking one or more control actions are taken based on information measured by sensor 102.

Operating the water recycle in closed-loop fashion can be beneficial to limit the amount of additional water processing needed to treat the recycled water before being supplied to water electrolysis cell 10. In some applications, makeup water may be supplied to the water supply forming feed stream 20 even when operating in closed-loop fashion to make up for the volume of water electrolytically decomposed and discharged from system 100 in the form of oxygen stream 112 and hydrogen stream 116. In other applications, no makeup water is supplied to the recirculating volume of water when operating in closed-loop fashion as the volume of water electrolytically decomposed may be comparatively small relative to the total volume of water flowing through system 100. In these applications, additional volume of water can enter the system when taking one or more control actions based on information measured by sensor 102.

During operation of system 100, membrane 16 may release impurities into the feedwater entering into water electrolysis cell 10 that are subsequently discharged from the cell along with excess water. The impurities may be caused by break-in of membrane 16 during initial operation, swelling of the membrane through use, and/or degradation of the membrane through use. The composition of the impurities may vary depending on the composition of membrane 16 but may include electrically conductive species, such as fluoride ions, sulfate ions, and/or other impurities released from the membrane. Other example impurities that may be released into the feed water include carbon species (Total Organic Content(TOC), which may include per-and polyfluoroalkyl substances (PFAS)). Still other example impurities that may enter the feed water include corrosion products (e.g., Fe, Cr, Ni, Mo, Mn, and/or Si), impurities from inadequate purification of the initial water (e.g., Na, Cl, SO4, B, Si, and/or TOC), and/or impurities catalyst leaching (e.g., Ir, Ru, and/or Pt).

To obtain data indicative of level of impurities in system 100, the system may include one or more sensors 102A-102Z (“sensor 102”). Such sensors can be implemented in number of different ways in system 100. For example, one or more of the sensors can be positioned in line with a flowing water stream (e.g., anode-side excess water stream 114, cathode-side excess water stream 118, combined excess water stream 120, and/or feedwater stream 20), either directly or via a slipstream pulled from the water stream. Alternatively, one or more of the sensors can be positioned to measure a static volume of water (e.g., at tank 122) that provides a measure of the impurities in excess water supplied to the tank and/or feedwater drawn from the tank.

In the illustrated example, sensor 102 is illustrated as being positioned to measure one or more characteristics indicative of a concentration of impurities in the combined excess water stream 120. In other applications, sensor 102 may be positioned to measure one or more characteristics indicative of a concentration of impurities in anode-side excess water stream 114, cathode-side excess water stream 118, and/or feedwater stream 20. Measurement of the feedwater can also be effective to provide a measurement associated with the excess water, since the excess water is recycled to supply the feedwater. When implemented as an online sensor, sensor 102 can continuously measure, and controller 106 may continuously receive, measurement information concerning one or more measured characteristics indicative of an impurity concentration in the water being measured.

In other applications, one or more of the sensors may be implemented as an off-line monitoring tool that is not in direct fluid communication with water being measured in system 100. In these applications, a water sample may be extracted from system 100 and transported to an off-line analysis system. Such off-line analysis may involve direct evaluation of the sample, e.g., using one or more sensors, or may involve further processing on the sample, such as performing wet chemistry processing on the sample to generate data associate with the sample. In either case, data generated by sensor 102 and/or otherwise associated with the water under evaluation can be received by controller 106, e.g., for storage in memory and/or further processing.

In some applications, sensor 102 is implemented as a fluoride ion sensor to determine a measured fluoride ion concentration in the water being analyzed. For example, when membrane 16 is a fluorinated polymeric membrane, the membrane may shed fluoride ion impurities into the water. In general, fluoride ion sensors are devices designed to detect and measure the concentration of fluoride ions (F⁻) . The sensors typically rely on electrochemical principles, where the fluoride ions interact with the sensor's electrode surface, producing a measurable electrical signal that is proportional to the concentration of fluoride ions. Common types of fluoride ion sensors that may be used include ion-selective electrodes (ISEs) and field-effect transistors (FETs), both of which are sensitive to the presence of fluoride. Ion-selective electrodes are often used in conjunction with a reference electrode and a membrane that selectively interacts with fluoride ions, generating a potential difference based on the fluoride concentration.

In operation, fluoride ion sensor 102 can measure, and controller 106 can receive, data indicate the fluoride ion concentration in the water being measured to provide a measured fluoride ion concentration in the water being analyzed. Controller 106 can compare the measured fluoride ion concentration to one or more fluoride ion concentration thresholds. The one or more fluoride ion concentration threshold(s) may correspond to fluoride ion concentration levels where control action may be taken to reduce or eliminate the continued accumulation of additional fluoride ions in the water being recycled in the system. For example, water electrolysis cell 10 may tolerate some amount of impurity in the feedwater supplied to the cell. When the impurity reaches a certain level, however, the impurity may begin to interfere with the operational performance of the water electrolysis cell. The one or more fluoride ion concentration thresholds may be set at a level corresponding to where the fluoride ion concentration in the water may interfere with the operational performance of water electrolysis cell 10 and/or a level below which meaningful operational performance deterioration is observed, to provide a margin of safety for interventional control action to be taken.

In some examples, the fluoride ion concentration threshold that controller 106 compares the measured fluoride ion concentration to is a value less than or equal to one part per million (1000 parts per billion), such as a value less than or equal to 500 ppb, less than or equal to 250 ppb, less than or equal to 100 ppb, less than or equal to 50 ppb, less than or equal to 25 ppb, less than or equal to 10 ppb, or less than or equal to 1 ppb. For example, the fluoride ion concentration threshold may be a value within a range from 250 ppb to one part per billion, such as from 50 ppb to one part per billion. The one or more thresholds can be programmed into memory 140 of controller 106, e.g., via a user interface associated with the controller, and in the controller can reference the stored one or more thresholds when performing analysis.

System 100 may include other sensors 102 that provide information concerning the state of the water being monitored in addition to, or in lieu of, a fluoride ion sensor. Such other sensors may provide alternative measures indicative of the presence and/or concentration of impurities in the water being measured. In some examples, system 100 includes a fluoride ion sensor and one or more other sensors, which may be identified as one or more secondary sensors. Each other sensor may measure a characteristic indicative of the water being measured, which may be identified as one or more secondary characteristics of the water being measured when system 100 includes a fluoride ion sensor measuring fluoride ion concentration as a first characteristic of the water. Example sensors 102 that may be implemented in system 100 in addition to or in lieu of a fluoride ion sensor maybe one or more sensors configured to measure oxidation-reduction potential, pH, conductivity, sulfate concentration, and/or combinations thereof of the water being monitored. The one or more other sensors 102 can measure, and controller 106 can receive, information concerning the measured one or more other characteristics of the water.

The one or more sensors 102 can measure, and controller 106 can receive, measurement information indicative of the presence and/or concentration of impurities in the water under analysis at any point during the lifecycle of water electrolysis cell 10. In some examples, system 100 operates so sensor 102 measures, and controller 106 receives, such measurement information at least during an initial break-in period following initial use of membrane 16. Membrane 16 may release a disproportionately large amount of impurities during the initial break in period (e.g., period of initial use following installation of the new membrane and water electrolysis cell 10). The initial break-in period may be a period of at least 50 hours following initial use of membrane 16, such as at least 100 hours, at least 150 hours, at least 200 hours, at least 250 hours, at least 300 hours, at least 400 hours, at least 500 hours, or at least 1000 hours. For example, the break-in period may range from 100 hours to 1000 hours, such as from 200 hours to 800 hours, or from 250 hours to 500 hours following initial use of membrane 16. System 100 may monitor via sensor 102 impurities in the water and controller 106 may take control actions based on the measured information at least during this break-in period. System 100 may or may not continue to similarly monitor and control after the break-in period.

As noted above, system 100 in the example of FIG. 2 also includes controller 106. Controller 106 can be communicatively connected to the sensor components and controllable components of system 100 to manage the overall operation of the system. For example, controller 106 can be communicatively connected to sensor 102, one or more valves, one or more pumps, and/or other controllable components of system 100.

Controller 106 includes processor 138 and memory 140. Controller 106 communicates with communicatively connected components via a wired or wireless connection. Controls signals sent from controller 106 and received by the controller can travel over the connection. Memory 140 stores software for running controller 106 and may also store data generated or received by processor 138, e.g., from sensors 102. Processor 138 runs software stored in memory 140 to manage the operation of system 100.

Controller 106 may be implemented using one or more controllers, which may be located at the facility site containing water electrolysis cell 10. Controller 106 may communicate with one or more remote computing devices 142 via a network 144. For example, controller 106 may communicate with a geographically distributed cloud computing network, which may perform any or all of the functions attributed to controller 106 in this disclosure.

Network 144 can be configured to couple one computing device to another computing device to enable the devices to communicate together. Network 144 may be enabled to employ any form of computer readable media for communicating information from one electronic device to another. Also, network 144 may include a wireless interface, and/or a wired interface, such as the Internet, in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router may act as a link between LANs, enabling messages to be sent from one to another. Communication links within LANs may include twisted wire pair or coaxial cable, while communication links between networks may utilize analog telephone lines, full or fractional dedicated digital lines, Integrated Services Digital Networks (ISDNs), Digital Subscriber Lines (DSLs), wireless links including cellular and satellite links, or other communications links. Furthermore, remote computers and other related electronic devices may be remotely connected to either LANs or WANs via a modem and temporary telephone link.

Controller 106 can receive data from sensor 102 deployed in system 100 and use data generated by the sensor to take control action in the system. For example, controller 106 can compare the measured fluoride ion concentration by sensor 102 to one or more fluoride ion concentration thresholds. If controller 106 determines that the measured fluoride ion concentration is below the fluoride ion concentration threshold, controller 106 may control system 100 to continue recycling the excess water from water electrolysis cell 10 back to serve as the supply for feed water 20 (e.g., without undergoing further purification or processing). Controller 106 may continue recycling the excess water by controlling one or more pumps pumping water through system 100 and/or by controlling one or more valves to continue recycling the excess water.

By contrast, if controller 106 determines that the measured fluoride ion concentration is at or above the fluoride ion concentration threshold, controller 106 may control system 100 to take a control action for the excess water generated by water electrolysis cell 10. Controller 106 may take a variety of different control actions to reduce the concentration of fluoride ions in the water and/or to increase the purity of the water supplied to water level electrolysis cell 10. As one example, controller 106 may control system 100 to have ultrapure water generation system 104 supply ultrapure water to water electrolysis cell 10 (e.g., alone or mixed with at least a portion of the recycled water). For example, controller 106 may control ultrapure water generation system 104, one or more pumps pumping water through system 100, and/or one or more valves controlling the flow of water through the system to supply ultrapure water from ultrapure water generation system 104 to water electrolysis cell 10.

In some examples, controller 106 controls system 100 so ultrapure water received from ultrapure water generation system 104 is supplied to water electrolysis cell 10 instead of supplying any excess water recycle to the water electrolysis cell. In other examples, controller 106 controls system 100 so ultrapure water received from ultrapure water generation system 104 is mixed with at least a portion of excess water recycle (e.g., thereby diluting the concentration of impurities in the water) for supply to water electrolysis cell 10. For example, controller 106 may control system 100 to deliver ultrapure water from ultrapure water system 104 to tank 122 where the ultrapure water mixes with a portion of the recycle excess water from water electrolysis cell 10 to form the supply for feed water 20.

Additionally or alternatively, controller 106 can control system 100 to divert at least a portion of the excess water generated by water electrolysis cell 10 to ultrapure water generation system 104 purification by the system. In the example of FIG. 2, for instance, system 100 is illustrated as including a water line 150 and controllable valve 152 that can deliver at least a portion of the excess water to ultrapure water generation system 104. Ultrapure water generation system 104 can purify the excess water (e.g., by removing ions) to generate a purified water that can be returned to the water system supplying water electrolysis cell 10.

As yet a further additional or alternative control action, controller 106 can control system 100 to divert at least a portion of the excess water out of the water system that supplies water electrolysis cell 10. For example, system 100 may include a water line 154 and a controllable valve 156 that can be used to deliver at least a portion of the excess water out of system 100. The water discharged from system 100 can be used in a variety of ways. The water may be discarded to waste. Additionally or alternatively, the water may be used elsewhere within the facility containing system 100. For example, the discharged water may be supplied to a cooling water system and uses a recirculating cooling water through one or more heat exchangers as part of the cooling water system.

When system 100 includes one or more other sensors 102 in additional to or in lieu of a fluoride ion sensor, controller 106 can additionally or alternatively take control actions based on the measured characteristic information by the one or more other sensors. For example, controller 106 can compare one or more measured secondary characteristics to one or more corresponding secondary characteristic thresholds stored in memory 140.

If the measured secondary characteristic by sensor 102 is below the secondary characteristic threshold (e.g., alone or in combination with the measured fluoride ion concentration being below the fluoride ion concentration threshold), controller 106 can control system 100 to continue recycling the excess water from water electrolysis cell 10 back to serve as the supply for feed water 20 (e.g., without undergoing further purification or processing). Controller 106 may continue recycling the excess water by controlling one or more pumps pumping water through system 100 and/or by controlling one or more valves to continue recycling the excess water. By contrast, if the measured secondary characteristic by sensor 102 is at or above the secondary characteristic threshold, controller 106 may control system 100 to take a control action for the excess water generated by water electrolysis cell 10. Controller 106 may take a variety of different control actions, including those discussed above as being control actions controller 106 can take if the measured fluoride ion concentration is at or above the fluoride ion concentration threshold.

When system 100 includes a fluoride ion sensor and a different sensor to measure a characteristic other than fluoride ion concentration, controller 106 may control system 100 to take one or more of the control actions for the excess water generated by water electrolysis cell 10 if either the measured secondary characteristic is above the secondary characteristic threshold or the measured fluoride ion concentration is above the fluoride ion concentration threshold. That can provide redundancy to help ensure that water of appropriate purity is supplied to water electrolysis cell 10.

In addition to recycle water as described herein, water electrolysis cell 10 can periodically or continuously receive ultrapure water from ultrapure water generation system 104. Ultrapure water generation system 104 may be implemented using one or more unit operations to purify water to a suitable level of purity. Example unit operations that may be implemented as part of ultrapure water generation system 104 include but are not limited to, passing the water through a media filter, passing the water through a reverse osmosis membrane (e.g., double pass reverse osmosis), performing ion exchange on the water using an ion exchange membrane, and/or irradiating the water with UV light.

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components, or integrated within common or separate hardware or software components. For example, features described as controllers herein such as controller 106 using computing hardware physically co-located with water electrolysis cell 10 or may be partially or fully physically remote from the membrane, such as implemented through a remote server, cloud-computing environment, or other physically remote computing device.

The techniques described in this disclosure may also be embodied or encoded in a computer-readable medium, such as a non-transitory computer-readable storage medium, containing instructions. Instructions embedded or encoded in a computer-readable storage medium may cause a programmable processor, or other processor, to perform the method, e.g., when the instructions are executed. Non-transitory computer readable storage media may include volatile and/or non-volatile memory forms including, e.g., random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable media.

Various examples have been described. These and other examples are within the scope of the following claims.

1. A method of monitoring and controlling water quality for a water electrolyzer, the method comprising:
supplying a feed water to a water electrolysis cell having a solid polymer electrolyte membrane and generating hydrogen and oxygen through electrolysis of the feed water supplied to the water electrolysis cell, wherein an excess water is discharged from the water electrolysis cell;
measuring, with a fluoride ion sensor, a fluoride ion concentration in the excess water to provide a measured fluoride ion concentration in the excess water;
comparing, by one or more processors, the measured fluoride ion concentration to a fluoride ion concentration threshold;
if the measured fluoride ion concentration is below the fluoride ion concentration threshold, recycling the excess water as the feed water to the water electrolysis cell; and
if the measured fluoride ion concentration is above the fluoride ion concentration threshold, taking a control action for the excess water.

2. The method of claim 1, wherein:
the water electrolysis cell generates a cathode discharge stream that is supplied to a hydrogen-water separator to separate a cathode-side excess water from hydrogen generated by the water electrolysis cell;
the water electrolysis cell generates an anode discharge stream that is supplied to an oxygen-water separator to separate an anode-side excess water from oxygen generated by the water electrolysis cell; and
measuring, with the fluoride ion sensor, the fluoride ion concentration in the excess water comprises measuring the fluoride ion concentration in the cathode-side excess water.

3. The method of claim 1, wherein:
the water electrolysis cell generates a cathode discharge stream that is supplied to a hydrogen-water separator to separate a cathode-side excess water from hydrogen generated by the water electrolysis cell;
the water electrolysis cell generates an anode discharge stream that is supplied to an oxygen-water separator to separate an anode-side excess water from oxygen generated by the water electrolysis cell;
the cathode-side excess water and the anode-side excess water are combined together to form a combined excess water; and
measuring, with the fluoride ion sensor, the fluoride ion concentration in the excess water comprises measuring the fluoride ion concentration in the combined excess water.

4. The method of claim 1, wherein:
the water electrolysis cell generates a cathode discharge stream that is supplied to a hydrogen-water separator to separate a cathode-side excess water from hydrogen generated by the water electrolysis cell;
the water electrolysis cell generates an anode discharge stream that is supplied to an oxygen-water separator to separate an anode-side excess water from oxygen generated by the water electrolysis cell; and
measuring, with the fluoride ion sensor, the fluoride ion concentration in the excess water comprises measuring the fluoride ion concentration in the anode-side excess water.

5. The method of claim 1, wherein recycling the excess water as the feed water to the water electrolysis cell comprises recycling the excess water as the feed water to the water electrolysis cell without processing the excess water to remove ions.

6. The method of claim 1, wherein the fluoride ion concentration threshold is a value less than or equal to 50 parts per billion.

7. The method of claim 1, wherein the solid polymer electrolyte membrane comprises a perfluorosulfonic acid polymer.

8. The method of claim 1, wherein the fluoride ion concentration in the excess water increases through multiple cycles of recycling the excess water as the feed water to the water electrolysis cell.

9. The method of claim 1, wherein measuring, with the fluoride ion sensor, the fluoride ion concentration in the excess water comprises measuring the fluoride ion concentration in the excess water continuously with the fluoride ion sensor installed online.

10. The method of claim 1, wherein the control action comprises supplying ultrapure water from an ultrapure water generation system to the water electrolysis cell.

11. The method of claim 10, wherein the control action comprises diverting at least a portion of the excess water to the ultrapure water generation system.

12. The method of claim 1, wherein the control action comprises diverting at least a portion of the excess water out of a water system for the water electrolysis cell.

13. The method of claim 1, further comprising:
measuring, with a secondary sensor, a secondary characteristic of the excess water to provide a measured secondary characteristic of the excess water;
comparing, by one or more processors, the measured secondary characteristic to a secondary characteristic threshold;
if the measured secondary characteristic is below the secondary characteristic threshold and the measured fluoride ion concentration is below the fluoride ion concentration threshold, recycling the excess water as the feed water to the water electrolysis cell; and
if either the measured secondary characteristic is above the secondary characteristic threshold or the measured fluoride ion concentration is above the fluoride ion concentration threshold, taking the control action for the excess water.

14. The method of claim 13, wherein the secondary characteristic comprises one or more of oxidation-reduction potential, pH, conductivity and sulfate concentration.

15. A method of monitoring and controlling water quality for a water electrolyzer, the method comprising:
operating a water electrolysis cell having a solid polymer electrolyte membrane that generates hydrogen and oxygen through electrolysis of a feed water supplied to the water electrolysis cell in a closed loop with excess water discharged from the water electrolysis cell recycled back as the feed water;
measuring, with a fluoride ion sensor, a fluoride ion concentration in the excess water to provide a measured fluoride ion concentration in the excess water;
comparing, by one or more processors, the measured fluoride ion concentration to a fluoride ion concentration threshold; and
when the measured fluoride ion concentration is above the fluoride ion concentration threshold, terminating closed loop operation of the water electrolysis cell by at least supplying ultrapure water from an ultrapure water generation system to the water electrolysis cell.

16. The method of claim 15, wherein:
the water electrolysis cell generates a cathode discharge stream that supplied to a hydrogen-water separator to separate a cathode-side excess water from hydrogen generated by the water electrolysis cell;
the water electrolysis cell generates an anode discharge stream that supplied to an oxygen-water separator to separate an anode-side excess water from oxygen generated by the water electrolysis cell;
the cathode-side excess water and the anode-side excess water are combined together to form a combined excess water that is supplied back as the feed water during closed loop operation; and
measuring, with the fluoride ion sensor, the fluoride ion concentration in the excess water comprises measuring the fluoride ion concentration in one or both of the cathode-side excess water and the combined excess water.

17. The method of claim 15, wherein the fluoride ion concentration threshold is a value less than or equal to 50 parts per billion.

18. The method of claim 15, wherein the solid polymer electrolyte membrane comprises a perfluorosulfonic acid polymer and the fluoride ion concentration in the excess water increases through multiple cycles of recycling during closed loop operation.

19. The method of claim 15, wherein terminating closed loop operation of the water electrolysis cell further comprises one or both of:
diverting at least a portion of the excess water to the ultrapure water generation system; and
diverting at least a portion of the excess water out of a water system for the water electrolysis cell.

20. The method of claim 15, further comprising:
measuring, with a secondary sensor, a secondary characteristic of the excess water to provide a measured secondary characteristic of the excess water;
comparing, by one or more processors, the measured secondary characteristic to a secondary characteristic threshold; and
terminating closed loop operation of the water electrolysis cell by at least supplying ultrapure water from an ultrapure water generation system to the water electrolysis cell if either the measured fluoride ion concentration is above the fluoride ion concentration threshold or the measured secondary characteristic is above the secondary characteristic threshold.

21. A water electrolysis system comprising:
a water electrolysis cell having a solid polymer electrolyte membrane, wherein the water electrolysis cell is configured to receive a feed water and generate hydrogen and oxygen through electrolysis of the feed water, and the water electrolysis cell is further configured to discharge excess water from the water electrolysis cell;
a fluoride ion sensor positioned to measure a fluoride ion concentration in the excess water to provide a measured fluoride ion concentration in the excess water;
an ultrapure water generation system in selective fluid communication with the water electrolysis cell; and
a controller configured to:
receive the measured fluoride ion concentration from the fluoride ion sensor;
compare the measured fluoride ion concentration to a fluoride ion concentration threshold;
if the measured fluoride ion concentration is below the fluoride ion concentration threshold, control recycling of the excess water as the feed water to the water electrolysis cell; and
if the measured fluoride ion concentration is above the fluoride ion concentration threshold, control supply of ultrapure water to the water electrolysis cell from the ultrapure water generation system.

22. The system of claim 21, comprising:
a hydrogen-water separator configured to receive a cathode discharge stream from the water electrolysis cell to separate a cathode-side excess water from hydrogen generated by the water electrolysis cell; and
an oxygen-water separator configured to receive an anode discharge stream from the water electrolysis cell to separate an anode-side excess water from oxygen generated by the water electrolysis cell;
wherein the cathode-side excess water and the anode-side excess water are combined together to form a combined excess water; and
the fluoride ion sensor is positioned to measure the fluoride ion concentration in one or both of the cathode-side excess water and the combined excess water.
